(19) United States
(12) Patent Application Publication
(10) Pub. No.: US 2003/0008644 A1
(43) Pub. Date: Jan. 9, 2003

(54) Preventing activation of audible incoming call indicators based on geographical area

(76) Inventors: Akhter Akhterzzaman, Naperville, IL (US); Paul Raymond Sand, Woodridge, IL (US); Richard Grant Sparber, Wheaton, IL (US)

Correspondence Address: GROSSMAN, PATTI & BRILL, ONE NORTH LASALLE STREET, 44TH FLOOR, CHICAGO, IL, 60602, US

(21) Appl. No.: 09/900,937

(22) Filed: Jul. 9, 2001

(51) Int. Cl. H04M 3/00

(52) U.S. Cl. 455/418; 455/567; 455/456

(57) ABSTRACT

An apparatus for and method of preventing activation of an audible incoming call indicator is provided. The prevention (307) may be performed at the infrastructure, such as at the mobile switching center (123), by not directing calls to the communication device (119 or 121). The prevention (209) may also be performed at the communication device (119 or 121), such as a cellular phone or pager, by deactivating the audible call indicator and/or turning to a vibrating or other non-audible call indicator.

### FIELD OF THE INVENTION

This invention relates to communication systems, including but not limited to function of communication devices based on geographical area within a communication system.

### BACKGROUND OF THE INVENTION

Various types of cellular communication systems are known to provide radio telephone service to a large number of mobile subscribers using a relatively small number of frequencies. Such service is provided by dividing a service area into a number of cells and reusing the frequencies in non-adjacent cells. This cellular principle has permitted a large growth in the amount of wireless telecommunications that may be carried over the allocated radio spectrum thus providing significant expansion in the number of wireless communication subscribers. Various different cellular protocols include analog, Frequency Division Multiple Access (FDMA), time division multiple access (TDMA), code division multiple access (CDMA), Global System for Mobile Communications (GSM), and Universal Mobile Telecommunications System (UMTS).

At certain times and/or places, audible incoming call indicators for communication devices such as cell phones or pagers may be inappropriate, disturbing, or otherwise disruptive. For example, in a house of worship, funeral parlor, or movie theatre, the sound of an incoming call is typically intolerable by others in attendance. The call recipient may have intended to turn off their phone or pager, and may simply have forgotten. Similarly, a user may remember to turn their device off prior to entering an area or event where ringing is disruptive, but may forget to turn their device back on after leaving the area or event, and may miss an important call or page.

Accordingly, there is a need for a method of automatically turning off audible incoming call indicators while a device is in a certain area or during a certain event, as well as a way to turn on ringing once the device leaves the area or the event ends.

### SUMMARY

A method of the present invention comprises the steps of storing, in a communication device, location information for one or more designated geographical areas. The communication device determines when it is within one of the one or more designated geographical areas. While the communication device is within one of the one or more designated geographical areas, activation of an audible incoming call indicator in the communication device is prevented.

### BRIEF DESCRIPTION OF THE DRAWINGS

FIG. 1 is a block diagram of a wireless communication system in accordance with the invention.

FIG. 2 is a flowchart illustrating a method of deactivating audible incoming call indicators by a communication device in accordance with the invention.

FIG. 3 is a flowchart illustrating a method of preventing activation of audible incoming call indicators to a communication device as performed by a system infrastructure in accordance with the invention.

### DESCRIPTION OF A PREFERRED EMBODIMENT

The following describes an apparatus for and method of preventing activation of an audible incoming call indicator. The prevention may be performed at the infrastructure, such as at the mobile switching center (MSC), by not directing calls to the communication device. The prevention may also be performed at the communication device, such as a cellular phone or pager, by deactivating the audible call indicator and/or turning to a vibrating or other non-audible call indicator.

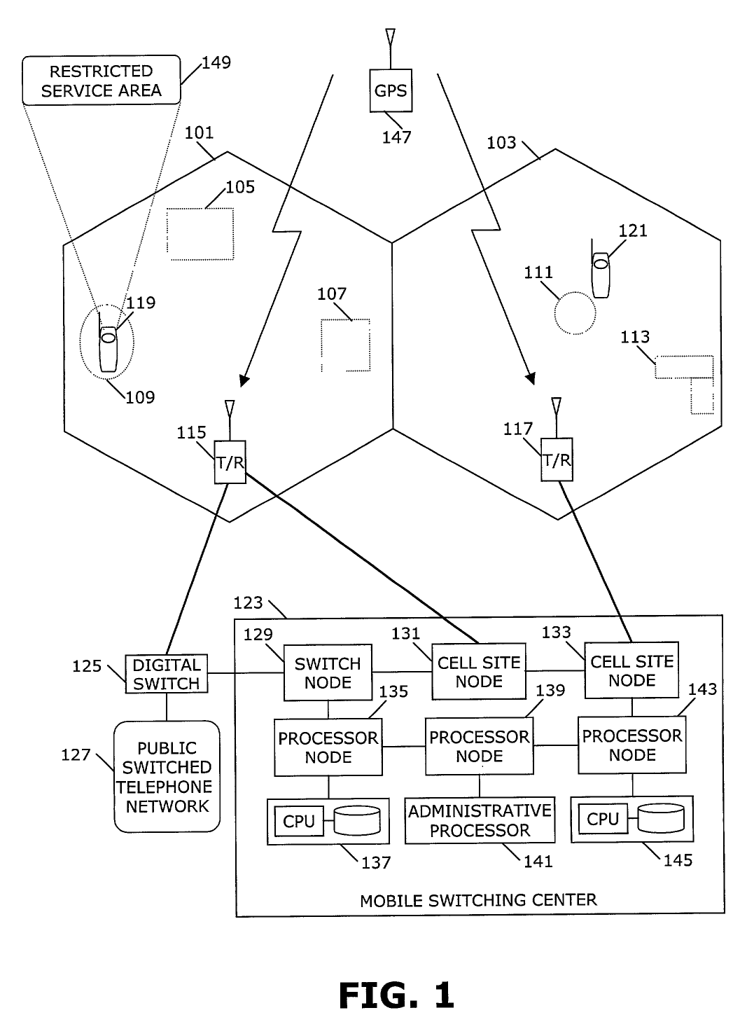

A block diagram of a wireless communication system is shown in FIG. 1. A plurality of geographic coverage areas 101 and 103, also referred to as cells, are each supported by cell sites. Only two coverage areas are shown for the sake of simplicity of the drawing, although the invention may be applied to a communication system having any number of coverage areas. The coverage areas 101 and 103 include one or more areas 105, 107, 109, 111, and 113 of restricted use. The areas include locations where audible call indicators, such as ringing, beeping, musical notes, and other audible sounds would be disruptive, inappropriate, and/or undesirable. Optionally, outgoing calls may be prohibited as well, although such a function may not necessarily be desirable in case of emergencies. Optional functionality may be provided if outgoing call prohibition is desired, e.g., allowing a cell phone to dial emergency facilities, e.g., the operator or 911, or convenient wireline access.

Restricted-use areas include, for example, hospitals, theaters, auditoriums, convention halls, funeral parlors, houses of worship, schools, courtrooms, prisons, restaurants, dangerous sections of road (such as construction zones or high traffic areas), and so forth. These areas of restricted use are supplied to the network providers by someone representative of the location, such as a hospital administrator, theater owner, and so forth. The owner/manager of an area where it is desired to restrict wireless device usage may supply local wireless providers with the location(s) where restricted usage is desired. A subscriber may provide restricted-use areas for there own use. Location information for the restricted-use areas may include coordinates defining the areas, such as coordinates of the four corners of a rectangular area, a center point and radius for a circular area, or other appropriate ways to designate various locations. The location information may be applicable only during designated periods of time and/or dates. For example, an auditorium manager may wish to restrict calls only during events at the auditorium, judges may only restrict call phone usage during trial hours in courtrooms (e.g., 9 AM to 5 PM), restaurant owners may only wish to restrict usage during business hours, and so forth. The location information may be provided only during the appropriate times or the location information may be provided with the times, and the communication device determines whether the designated area and time are both applicable before preventing activation of audible incoming call indicators.

Each cell site includes, for example, a call processor and one or more transceivers (T/R) 115 and 117 that provide wireless communications to communication devices, such as cellular phones, pagers, or other such wireless devices 119 and 121 located in the coverage areas defined for the cell site. The transceivers 115 and 117 are connected to a mobile switching center (MSC) 123 via bidirectional transmission facilities that connect to trunks, voice radio links, and control radio links. Although only one transceiver 115 is shown connected to a digital switch 125 for illustrative purposes, all transceivers in the system are connected to the digital switch 125. Two transceivers are shown for the sake of simplicity, although one or more transceivers may serve at each cell site in the system. Only two communication devices, as are commercially available, are shown although many subscribers are served by the system. In this example, the digital switch 125 is connected to the public-switched telephone network (PSTN) 127.

The MSC 123 may be any mobile switching center, including those manufactured and sold by Lucent Technologies and other infrastructure providers, and including those having architectures different than the one shown in FIG. 1. The example MSC 123 shown in FIG. 1 comprises a plurality of interconnected nodes and a plurality of processors for administering wireless communication services and storing subscriber data. The digital switch 125 is interconnected to the MSC 123 via a switch node 129. In this embodiment, a cell site node 131 serves one transceiver 115 and its associated site and another cell site node 133 serves the other transceiver 117 and its associated site. The switch node 129 is an interface between the MSC 123 and the digital switch 125.

A processor node 135 is connected to a call processor 137, which includes a central processing unit (CPU) and a database. The database stores information including authentication algorithms, control information, and other information relevant to the cell sites served by the process node 135. Another processor node 139 connects to an administrative processor 141, which performs maintenance functions and other administrative tasks for the MSC 123, as known in the art. A third processor node 143 connects to a call processor 145, which also includes a CPU and a database. The database also stores information including authentication algorithms, control information, and other information relevant to cell sites served by the third process node 143.

During normal operation, the call processors 137 and 145 receive registration (access) requests from and calls directed to communication device 119 and 121 located in the coverage areas 101 and 103. These registration requests may be in the form of a call origination request occurring when a subscriber places a call, a termination request when a subscriber receives a call, or an autonomous registration occurring when a subscriber simply turns a mobile terminal “on”. The call processors determine the authenticity of each mobile terminal requesting access, and establish voice channels, control channels, or call connections for the mobile terminal in accordance with procedures well known in the art.

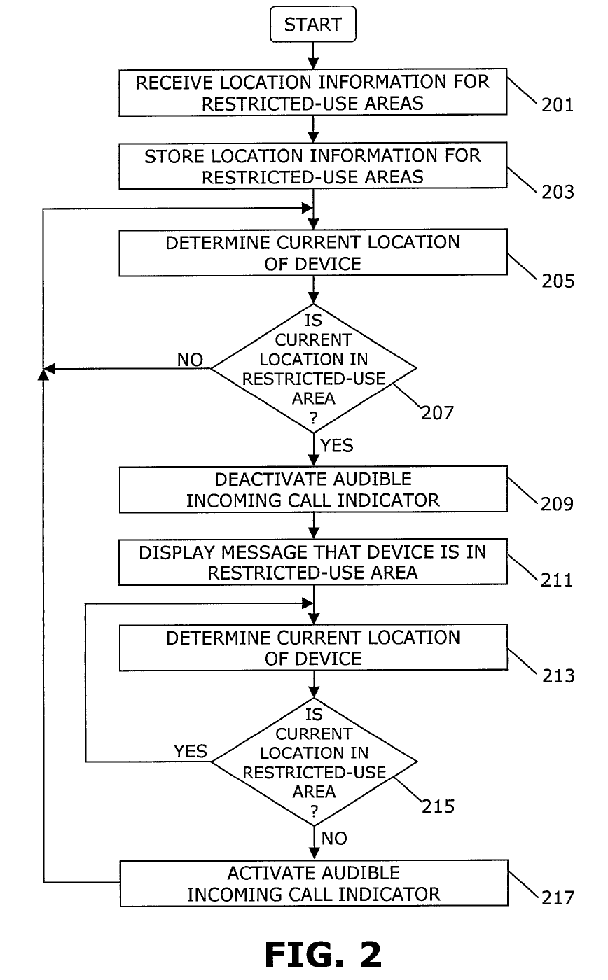

A flowchart illustrating a method of deactivating audible incoming call indicators by a communication device is shown in FIG. 2. At step 201, location information for restricted-use areas is received at a communication device 119. The location information may include location coordinates and/or time duration and/or application day(s) of restricted-use areas. At step 203, the location information is stored in the communication device. The location information may be transmitted to the communication device 119 from the infrastructure or may be programmed directly into the communication device 119. Although the receiving 201 and storing 203 steps are shown at a particular part of the flowchart, these steps may occur at any time. For example, when a communication device enters a coverage area for a new site, restricted area location information for the new coverage area may then be transmitted to the communication device.

At step 205, the communication device 119 periodically determines its current location. The communication device 119 determines its location in any number of ways as known in the art. For example, satellite-based GPS may be utilized, whereby timing and location information are transmitted from a satellite directly to a Global Positioning System (GPS) receiver, as known in the art. Another way to determine location information, known as cellular-based GPS, includes retransmission, via the transceivers 115 and 117, of GPS data, as known in the art. When the communication device 119 is not within a restricted-use area, the process continues with step 205. When the communication device 119 is within a designated area 109 at step 207, as determined by comparing the device's current location with the stored location information, the process continues with step 209, where the device's audible incoming call indicator is deactivated. The device 119 may simply deactivate its incoming call indicator or may switch the incoming call indicator to vibrate mode or another non-audible incoming call indicator. The device 119 may optionally display a message indicating that the device is in a restricted-use area on the device's display 149.

At step 213, the communication device 119 periodically determines its current location, as described above. While the communication device 119 remains within any restricted-use area, the process continues with step 213. The device 119 may move between contiguous restricted-use areas without exiting restricted-use mode. When the communication device 119 leaves a designated area at step 215, as determined by comparing the device's current location with the stored location information, the process continues with step 217, where the device's audible incoming call indicator is activated and, optionally, if a message was displayed indicating that the device is in a restricted-use area, the message is discontinued, and the process continues with step 205.

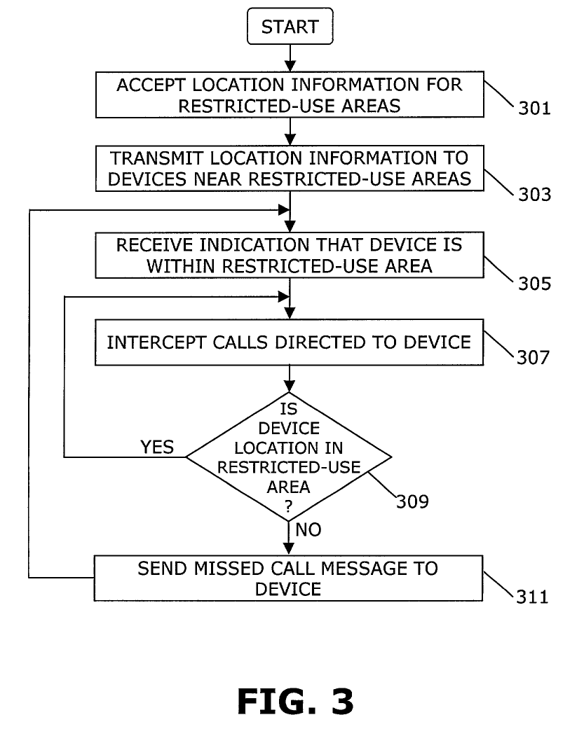

A flowchart illustrating a method of preventing activation of audible incoming call indicators to a communication device as performed by a system infrastructure is shown in FIG. 3. The flowchart is performed at the infrastructure of a wireless communication system, such as in the call processors 137 and/or 145 in the MSC 123. At step 301, location information is accepted by the provider of the wireless communication system. At step 303, the location information is transmitted to the communication devices near the restricted-use areas. For example, transceivers 115 and 117 at each cell site transmit restricted-use location information to the communication devices in that coverage area. For example, information regarding three locations 105, 107, and 109 in the first area 101 are transmitted by the first transceiver 115 to communication devices 119 in the first area 101, and information regarding two locations 111 and 113 in the second area 103 are transmitted by the second transceiver 117 to communication devices 121 in the second area 103. Although the accepting 301 and transmitting 303 steps are shown at a particular part of the flowchart, these steps may occur at any time. For example, when new location information is provided, it may be immediately transmitted to the communication devices in the relevant coverage area. Adding or deleting a restricted-use area may also be handled by request in a real-time manner. For example, an area may become restricted or unrestricted while a communication device is in the area. For example, in areas where traffic increases above a certain level, the areas may become restricted-use areas while the areas have traffic above a predetermined level. If the communication device 119 is appropriately coupled to a moving vehicle's speedometer, or if the communication device 119 determines a speed by determining the distance between two different locations and dividing by the time between the locations, the device 119 may be restricted from receiving calls while the vehicle travels above a predetermined speed, because traveling at such a speed may be considered dangerous. In the instance where speed is a determining factor in creating a restricted-use, the restricted-use area may be any road or a more simple default may be any area, i.e., any place where the communication device 119 travels above a predetermined speed.

At step 305, the infrastructure receives an indication from a communication device 119 that it has entered a restricted-use area 109. At step 307, the infrastructure intercepts, i.e., does not deliver, calls directed to the device 119. Optionally, the calls may be sent to voice mail, and may have a special service provider-defined message associated with them. Until the infrastructure receives an indication from the communication device 119 that it has left the restricted-use area at step 309, or if the area becomes unrestricted while the device is in the area, the process continues with step 307. Once the infrastructure receives an indication from the communication device 119 that it has left the restricted-use area at step 309, the process continues with step 311, where the infrastructure may optionally send a missed call message to the communication device 119 for any calls intercepted at step 307, and the process continues with step 305. The missed call message may optionally ring the device 119.

The methods of the flowcharts shown in FIG. 2 and FIG. 3 may be implemented in software and stored on a computer-readable signal-bearing medium, which is well known in the art.

The present invention provides the ability to automatically prevent activation of audible call indicators from being disruptive while a communication device is within a designated area. Once the communication device leaves the designated area, audible call indicators are automatically activated. Audible call indicator activation may be prevented either at the communication device or at the infrastructure of the communication system. The invention may be applied to any type of device that has an incoming call indicator, such as a cellular phone or pager. A user does not need to remember to disable audible incoming call indicators in particular areas, thereby preventing disruptions and/or embarrassment. Further, the user does not need to remember to re-enable the indicators after leaving such an area, thereby eliminating missed calls. The owner or manager of a restricted-use area is able to maintain control over disruptions without bothering their customers. In a hospital setting, prevention of incoming calls reduces the chance of cell phone use disrupting sensitive life-saving equipment. Reception of calls in moving vehicles may be restricted in areas of high traffic or when the vehicle travels above a certain speed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
storing, in a communication device, location information for one or more designated geographical areas;
determining, by the communication device, when the communication device is within one of the one or more designated geographical areas;
preventing activation of an audible incoming call indicator in the communication device while the communication device is within one of the one or more designated geographical areas.

2. The method of claim 1, wherein the location information is stored as one or more coordinates defining boundaries of the one or more designated geographical areas.

3. The method of claim 1, wherein at least some of the location information is stored for the duration of an event.

4. The method of claim 1, wherein the location information is transmitted to the communication device by an infrastructure of a communication system.

5. The method of claim 1, wherein the location information, is transmitted to the communication device when the communication device enters a coverage area of a cell site and the one or more designated geographical areas are within the coverage area.

6. The method of claim 1, wherein the step of preventing comprises switching the audible incoming call indicator to a vibrating incoming call indicator.

7. The method of claim 1, further comprising the step of displaying a message on a display for the communication device indicating that the communication device is within one of the one or more designated geographical areas.

8. The method of claim 1, further comprising the step of informing the infrastructure when the communication device is within one of the one or more designated geographical areas.

9. The method of claim 8, further comprising the step of intercepting calls intended for the communication device while the communication device is within one of the one or more designated geographical areas.

10. The method of claim 9, further comprising the step of sending missed call messages to the communication device for any calls received while the communication device is within one of the one or more designated geographical areas.

11. The method of claim 1, further comprising the steps of determining, by the communication device, when the communication device is no longer within the one of the one or more designated geographical areas and automatically reactivating the audible incoming call indicator in the communication device when the communication device is no longer within the one of the one or more designated geographical areas.

12. The method of claim 1, further comprising the steps of determining, by the communication device, when the communication device is no longer within the one of the one or more designated geographical areas and informing the infrastructure when the communication device is no longer within one of the one or more designated geographical areas.

13. The method of claim 1, where in the step of determining comprises determining when the communication device travels above a predetermined speed and considering such travel to be one of the one or more designated geographical areas.

14. A method comprising the steps of:
transmitting, to a communication device, location information for one or more geographical areas wherein use of audible incoming call indicators is restricted;
receiving, from the communication device, an indication that the communication device is within one of the one or more designated geographical areas;
intercepting calls intended for the communication device while the communication device is within one of the one or more designated geographical areas.

15. The method of claim 14, wherein the location information is transmitted to the communication device when the communication device enters a coverage area of a cell site and the one or more designated geographical areas are within the coverage area.

16. The method of claim 14, further comprising the step of sending missed call messages to the communication device for any calls received while the communication device is within one of the one or more designated geographical areas.

17. A computer-readable signal-bearing medium comprising:
computer readable program code for storing location information for one or more designated geographical areas;
computer readable program code for determining when a communication device is within one of the one or more designated geographical areas;
computer readable program code for preventing activation of an audible incoming call indicator in the communication device while the communication device is within one of the one or more designated geographical areas.

18. The computer-readable signal-bearing medium of claim 17, further comprising computer readable program code for receiving the location information from an infrastructure of a communication system.

19. The computer-readable signal-bearing medium of claim 17, wherein the computer readable program code for preventing activation of an audible incoming call indicator in the communication device while the communication device is within one of the one or more designated geographical areas comprises computer readable program code for switching the audible incoming call indicator to a vibrating incoming call indicator.

20. The computer-readable signal-bearing medium of claim 17, further comprising computer readable program code for displaying a message on a display for the communication device indicating that the communication device is within one of the one or more designated geographical areas.

21. The computer-readable signal-bearing medium of claim 17, further comprising computer readable program code for informing an infrastructure when the communication device is within one of the one or more designated geographical areas.

22. The computer-readable signal-bearing medium of claim 17, further comprising computer readable program code for determining, by the communication device, when the communication device is no longer within the one of the one or more designated geographical areas and automatically reactivating the audible incoming call indicator in the communication device when the communication device is no longer within the one of the one or more designated geographical areas.

23. The computer-readable signal-bearing medium of claim 17, further comprising computer readable program code for determining when the communication device travels above a predetermined speed and considering such travel to be one of the one or more designated geographical areas.
